(19) United States
(12) Patent Application Publication
(10) Pub. No.: US 2009/0225364 A1
(43) Pub. Date: Sep. 10, 2009

(54) JOB PROCESSING SYSTEM, CONTROL METHOD AND RECORDING MEDIUM

(75) Inventor: Eiichi Sato, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/399,284

(22) Filed: Mar. 6, 2009

(30) Foreign Application Priority Data
Mar. 6, 2008 (JP) 2008-056495

(51) Int. Cl. G06F 3/12

(52) U.S. Cl. 358/1.15; 340/540

(57) ABSTRACT

A method for controlling a job processing system for causing a job processing unit to execute a job, including performing a plurality of priority functions, which cause the job processing unit to execute a job in priority to a job being executed and/or waiting to be executed, and collectively inhibiting the plurality of priority functions upon receiving a request for collectively inhibiting the plurality of priority functions.

### BACKGROUND OF THE INVENTION

1. Field of the Invention

The present invention relates to a job processing system, a control method and a recording medium, more specifically, causing a job processing unit to execute a job.

2. Description of the Related Art

An apparatus for executing a job such as a printing apparatus or a digital multifunction peripheral has a function for executing a job in priority to another job being executed or waiting to be executed (hereinafter referred to as a “priority function”) as disclosed in Japanese Patent No. 3592088.

For example, the digital multifunction peripheral has a plurality of types of priority functions such as an interrupt copy function and a priority print function. Such priority functions can be used when an operator selects an operation on an operation unit.

However, there has been a drawback that an improper use of such a priority function causes delay of a job that is normally supposed to be executed. For example, it is assumed that a job normally supposed to be executed is being executed or waiting to be executed in a digital multifunction peripheral. In this situation, if any of the priority functions is used for a subsequent job input afterward, the subsequent job is executed in priority to the job, which is supposed to be executed. In addition, there is another drawback that if a lower priority is given to the job, which was supposed to be executed, resources prepared for the job, which was originally supposed to be executed, such as a printing paper, is erroneously used for the subsequent job, which is executed using the priority function.

### SUMMARY OF THE INVENTION

According to an aspect of the present invention, a job processing system for causing a job processing unit to execute a job, includes a processing unit configured to perform a plurality of priority functions, which cause the job processing unit to execute a job in priority to another job being executed or waiting to be executed, and a control unit configured to inhibit collectively the plurality of priority functions upon receiving a request for inhibiting collectively the plurality of priority functions.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a flowchart according to an embodiment of the present invention.

FIG. 2 is a flowchart according to an embodiment of the present invention.

FIG. 3 is a view illustrating a user interface according to an embodiment of the present invention.

FIG. 4 is a view illustrating a user interface according to an embodiment of the present invention.

FIG. 5 is a view illustrating a user interface according to an embodiment of the present invention.

FIG. 6 is a view illustrating a user interface according to an embodiment of the present invention.

FIG. 7 is a view illustrating a user interface according to an embodiment of the present invention.

FIG. 8 is a view illustrating a user interface according to an embodiment of the present invention.

FIG. 9 is a view illustrating an overall configuration of a job processing system according to an embodiment of the present invention.

FIG. 10 is a view illustrating a user interface according to an embodiment of the present invention.

FIG. 11 is a view illustrating a user interface according to an embodiment of the present invention.

FIG. 12 is a block diagram illustrating a configuration of a digital multifunction peripheral according to the present embodiment.

### DETAILED DESCRIPTION OF THE EMBODIMENTS

Various exemplary embodiments, features, and aspects of the invention will be described in detail below with reference to the drawings.

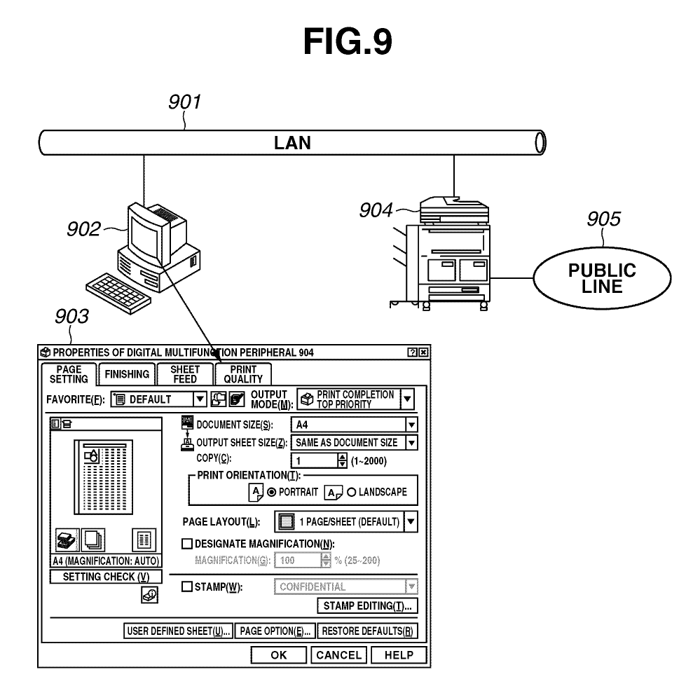

FIG. 9 is a view illustrating an overall configuration of a job processing system according to an embodiment of the present invention. The job processing system according to the present embodiment includes a digital multifunction peripheral 904 to be applied as a job processing unit and the digital multifunction peripheral 904 is configured to execute a plurality of jobs.

The digital multifunction peripheral 904 is configured to communicate data with various types of external apparatuses such as an computer device 902 through various types of communication media such as LAN 901 and a public line 905 and to execute a job requested from the outside.

An external apparatus such as the computer device 902 is provided with various types of remote user interfaces used to remote-operate the digital multifunction peripheral 904. Through the remote user interface, various types of instructions are given to the digital multifunction peripheral 904 by an operator. For example, various types of settings for a job to be input into the digital multifunction peripheral 904 can be made by an operator on a screen 903 displayed by the computer device 902.

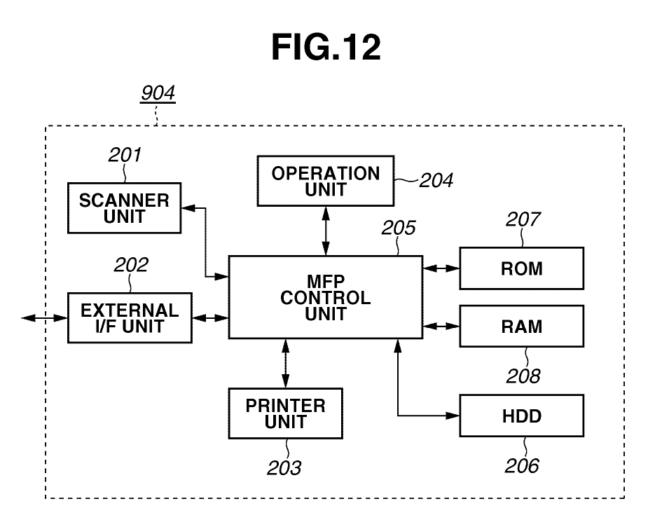

Next, referring to a block diagram of FIG. 12, a configuration of the digital multifunction peripheral 904 will be described.

The digital multifunction peripheral 904 includes a scanner unit 201, an external I/F unit 202, a printer unit 203, an operation unit 204, a MFP control unit 205, an HDD (hard disk drive) 206, a ROM 207 and a RAM 208.

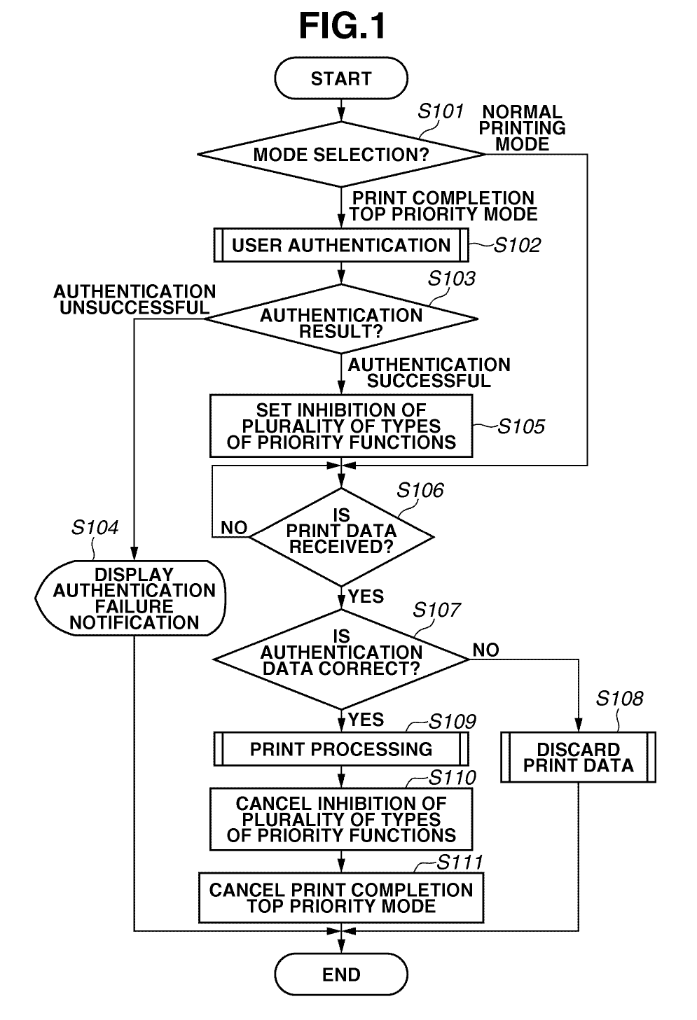

The MFP control unit 205 realized by a CPU comprehensively controls processing and operations of various units included in the digital multifunction peripheral 904. The ROM 207 stores various types of computer programs executed by the MFP control unit 205. For example, the ROM 207 stores a program for making the MFP control unit 205 perform various operations of a flowchart in FIG. 1 described below and a display control program required to display various setting screens as described below. The ROM 207 stores a program for causing the MFP control unit 205 to execute operations for interpreting a PDL (page description language) code data received from the computer device 902 and rasterizing the interpreted data. In addition, the ROM 207 stores a boot sequence and font information. A RAM 208 stores image data sent from the scanner 201 or the external I/F unit 202, and various programs and preset information loaded from the ROM 207. Writing and reading of data into/from the ROM 208 are executed under control of the MFP control unit 205.

The HDD (hard disk drive) 206 includes a hard disk and a drive unit for reading and writing data from/into the hard disk. The HDD 206 is a mass storage device for storing image data input from the scanner 201 or the external I/F 202. The MFP control unit 205 can output the image data stored in HDD 206 to the printer 203 for printing based on an instruction from a user. In addition, the MFP control unit 205, based on an instruction from a user, sends the image data stored in the HDD 206 to an external apparatus such as a computer device 902 through the external I/F 202.

Next, a priority function in the job processing system according to the present embodiment will be described.

The job processing system according to the present embodiment is configured to use a plurality of priority functions, which cause the digital multifunction peripheral 904 to execute a job in priority to another job being executed and/or waiting to be executed.

For example, the digital multifunction peripheral 904 illustrated in FIG. 9 has the following priority functions 1, 2, 3. Such priority functions can be selectively used in the digital multifunction peripheral 904 when an operator selects an operation through the operation unit 204.

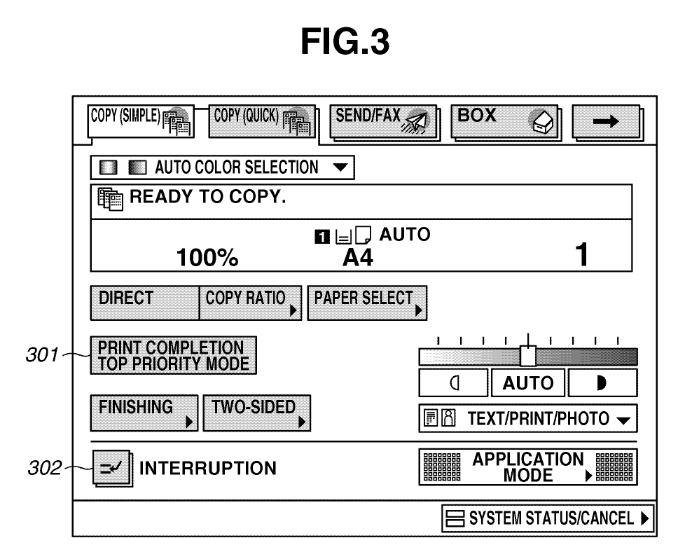

Priority Function 1 is an interrupt copy function. This function allows a printer 203 to print a job (copy job) in priority to another job under printing. This function temporarily interrupts a copy job, a print job or a facsimile job under printing and prints another copy job of a higher priority. When an operator presses a button (button 302 in FIG. 3) provided on the digital multifunction peripheral 904 for selecting the function, the digital multifunction peripheral 904 performs operations according to the function.

For example, it is assumed that while the digital multifunction peripheral 904 prints a certain job (job A), the interrupt copy function is selected for a copy job (job B) that is input later. Then, printing of the job A is interrupted and printing of the job B starts.

Upon completion of printing the job B, printing of the job A that was interrupted is restarted by the digital multifunction peripheral 904.

Upon receiving an instruction for using the priority function, the MFP control unit 205 performs control to cause the digital multifunction peripheral 904 to execute a newly received job in priority to a job being executed.

Priority Function 2 is a priority print function. This function is used to allow the printer 203 to print a job waiting to be printed in priority to another waiting job.

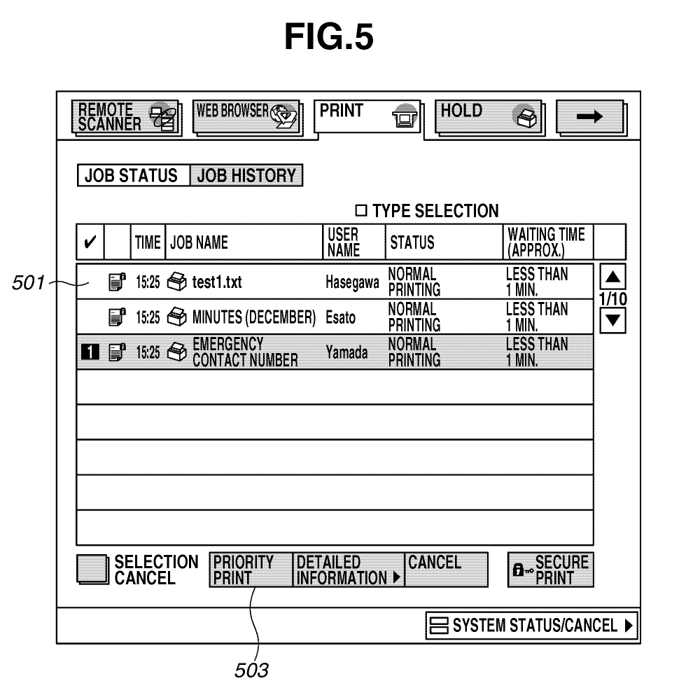

This function is used when a job being printed and further, a plurality of jobs waiting to be printed exist in the digital multifunction peripheral 904. The function is used for preferentially printing a job selected by an operator among a plurality of jobs waiting to be printed. When an operator presses a button (button 503 in FIG. 5) to select the function in the digital multifunction peripheral 904, the digital multifunction peripheral 904 performs operations according to the function.

Priority Function 3 is an overtaking printing function. This function is used when resources, such as printing paper or staple, needed for a print job (preceding job) that is to be processed are in a short supply and another printable job (subsequent job) is processed instead of the preceding job. By using this function, an executable subsequent job can be processed in priority to a preceding job that is to be interrupted because of shortage of resources.

The digital multifunction peripheral 904 performs operations according to the priority function selected by an operator among the priority functions 1 to 3.

Next, control for a plurality of priority functions available for the digital multifunction peripheral 904 is described.

The job processing system according to the present embodiment is capable of collectively (by one operation) inhibiting a plurality of priority functions available for the digital multifunction peripheral 904. On this point, more detailed description will be made below.

The job processing system according to the present embodiment is configured to receive a request for collectively inhibiting the above-described plurality of priority functions (request for collective inhibition of a plurality of priority functions) from an operator through a user interface (hereinafter referred to as UI).

In the present embodiment, this request is issued from an operator through UI (operation screen including a button 301 in FIG. 3) provided on the digital multifunction peripheral 904. Upon receiving the request for collectively inhibiting the plurality of functions through the UI, the MFP control unit 205 performs control to collectively/concurrently inhibit the plurality of priority functions. Such function control (restriction) is performed by the MFP control unit 205.

It is to be noted that in the present embodiment, the digital multifunction peripheral 904 has various available functions (non-priority functions) in addition to the above-described plurality of priority functions

For example, the digital multifunction peripheral 904 has the following non-priority functions, each of which does not fall into the above-described priority function. The digital multifunction peripheral 904 performs an operation according to such non-priority functions when an operator selects the operation.

One non-priority function is an E-mail send function for scan images. This function is for converting the data scanned by a scanner provided on the digital multifunction peripheral 904 into a predetermined image data format, then attaching the data to e-mail and sending an e-mail to a specified address. This function allows a user to easily obtain a scan image using a scanner attached to the digital multifunction peripheral that is connected with a network without locally connecting the scanner to a computer device.

In the present embodiment, even during a period in which the plurality of priority functions are collectively inhibited as described above, the MFP control unit 205 can control the non-priority function to be available for the digital multifunction peripheral 904. The number of such non-priority functions may be one or more than one.

The digital multifunction peripheral 904 according to the present embodiment is capable of adding a new function later, such as an optional function. For example, in the case of adding the optional function, the MFP control unit 205 performs control to communicate with an external server through the external I/F unit to download a program for the optional function, which is added to a given memory, such as the ROM 207 or the HDD 206. The subject function becomes available for the digital multifunction peripheral 904 by reading and executing the downloaded program.

Since functions can be added afterward, a number of functions at one point may be larger than a number of functions available before in the digital multifunction peripheral 904. Accordingly, in the present embodiment, when a request for collective inhibition of priority functions is input by an instruction through a button 301, the MFP control unit 205 searches for functions falling into the above-described priority functions among those available for the digital multifunction peripheral 904 at that time, and performs control to collectively inhibit a plurality of the priority functions found by this search.

Next, description will be made on various types of processing and control to be performed during a period in which the plurality of priority functions are inhibited in the digital multifunction peripheral 904.

The job processing system according to the present embodiment is configured to enable inputting of a job to be primarily executed without being interrupted by any other job (hereinafter referred to as a “job X”) into the digital multifunction peripheral 904 during a period in which a plurality of priority functions are being collectively inhibited as described above.

For example, in processing operations illustrated in a flowchart described below, a remote job from the computer device 902 is received as the job X by the external I/F unit 202 during a period in which the priority functions 1 to 3 are collectively inhibited.

In the present embodiment, the MFP control unit 205 controls the digital multifunction peripheral 904 to execute the job X received during a period in which the plurality of priority functions are collectively inhibited without having an influence of any other job.

For example, when a job X is being executed or waiting to be executed, if another job (subsequent job Y) is newly input subsequent to the job X, the MFP control unit 205 performs control to prevent use of any of above-described priority functions for the job Y. Thus, during a period for executing the job X, the priority functions are locked to prevent their use.

In this way, the MFP control unit 205 inhibits the digital multifunction peripheral 904 from executing the job Y that is input later in priority to the job X. Any subsequent job such as the job Y, which is input later than the job X, and executed in delayed timing (execution is postponed), is controlled to be on a standby condition until the job X is completed. While maintaining this state (in other words, all the priority functions being inhibited), the MFP control unit 205 controls the digital multifunction peripheral 904 to execute the job X. In the present embodiment, such various types of job control are executed by the MFP control unit 205.

The job Y is a job, for which any function exemplified as the priority functions 1 to 3 can be used, but a subsequent job attempting to use the interrupt copy function is not actually input as a print job. This is because the interrupt copy button 302 is controlled to be grayed out before inputting the job. This processing is shown as an example and is not limited thereto. As described above, in the present embodiment, a job actually input into the digital multifunction peripheral 904 or a job that can be input into the digital multifunction peripheral 904 is indicated as a job X, and a subsequent job that delays execution of the job X is indicated as a job Y.

As described above, the job processing system according to the present embodiment has a structure for preventing (inhibiting/restricting) the digital multifunction peripheral 904 from using the priority function for a subsequent job Y which is input after the job X. In addition, the present embodiment has a structure for enabling execution of the input job X by the digital multifunction peripheral 904 without executing another job in a higher priority while inhibiting execution of a job Y in priority to the job X.

This structure enables prevention of a trouble such that the priority function is improperly used for a subsequent job after the job X is input. Further a problem that execution of the job X is improperly postponed because of occurrence of such a trouble can be prevented.

As described above, the job processing system according to the present embodiment provides a structure which prevents improper use of the priority function that executes a job in priority to another job being executed and/or waiting to be executed. As a consequence, delay of a job that is supposed to be executed is prevented.

According to the present embodiment, non-priority functions are usable and not inhibited even if the priority function is inhibited as described above, which will be described below.

For example, the job processing system according to the present embodiment accepts a job using a function which does not fall into the plurality of priority functions and which is different from the one used for the job X (hereinafter referred to as a job Z) even when the plurality of priority functions are collectively inhibited. The image data required for a job to be executed by the digital multifunction peripheral 904 can be input from any input source such as the scanner 201, HDD 206 and the external I/F unit 202. Such a job to be executed by the digital multifunction peripheral 904 is not limited to the job Z but can be any jobs. An instruction for executing the job can be received from both a local UI and a remote UI.

When the job Z is accepted, the MFP control unit controls the digital multifunction peripheral 904 to execute the job Z even during a period in which the plurality of priority functions are collectively inhibited as described above. In this case, the MFP control unit 205 allows the digital multifunction peripheral 904 to execute the job Z in parallel to execution of the job X. In this way, parallel operations of the job X and the job Z are permitted during this period. Detailed description on this point will be made below.

For example, the MFP control unit 205 executes a job (which falls into the job X) received from the computer device 902 using the digital multifunction peripheral 904 in a state use of the three types of priority functions (interrupt copy function, priority print function and overtaking printing function) is inhibited. When a transmission job (which falls into the job Z) using an e-mail function is received, the MFP control unit 205 executes the job Z with the digital multifunction peripheral 904 in parallel to execution of the job X while the inhibition state is maintained.

In this way, the job processing system according to the present embodiment is configured to execute a different job having no influence upon a job which is to be normally executed, even if the plurality of priority functions are collectively inhibited. Thus, all subsequent jobs are not concurrently restricted to surely execute the job X.

Further, in the present embodiment, the MFP control unit 205 performs control so that inhibition of the plurality of priority functions is collectively and concurrently cancelled, provided that the job X has been executed (completed) by the digital multifunction peripheral 904. Thus, the collective cancellation of the inhibition state of the priority functions is controlled by the MFP control unit 205. Further, if any of the priority functions is selected for the job Y after the collective cancellation of the priority functions, the MFP control unit 205 controls the digital multifunction peripheral 904 to execute the job Y using the selected priority function.

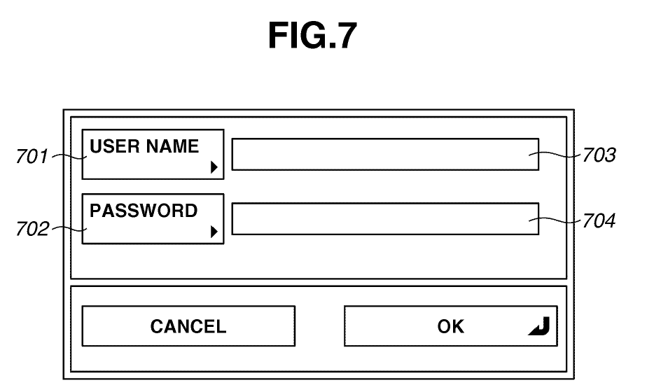

In addition, in the job processing system according to the present embodiment, operator information for identifying an operator is input via UI before a request for concurrently inhibiting the plurality of types of priority functions is received. In the present embodiment, the operator information is input through a screen of FIG. 7, which will be described below. The screen of FIG. 7 having the operator information input function is displayed on the operation unit 204.

The MFP control unit 205 determines whether to accept the request from the operator information input through the screen of FIG. 7. If the request is accepted based on a result of the determination, the MFP control unit 205 collectively inhibits a plurality of priority functions by using the digital multifunction peripheral 904, as described above.

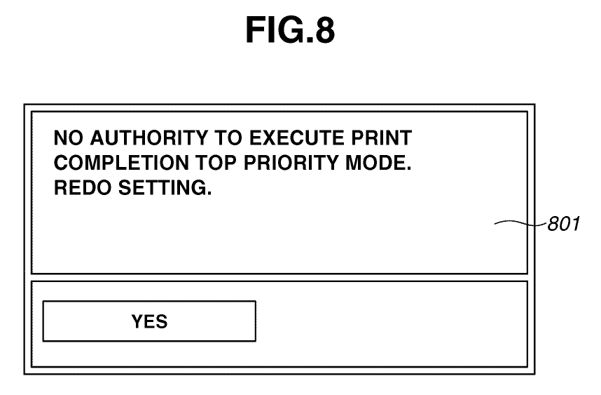

If it is determined that the request is unacceptable based on the operator information input on the screen of FIG. 7, the MFP control unit 205 discards (rejects) the request and displays a warning screen 801 of FIG. 8 on the operation unit 204 indicating that the request is unacceptable.

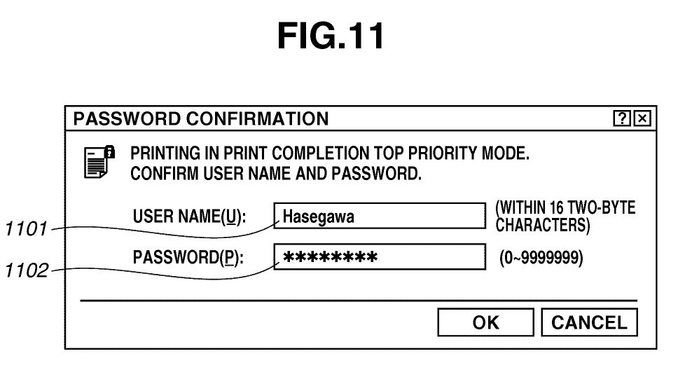

Further, the job processing system according to the present embodiment prompts the operator to input a password necessary to execute the job X after reception of the request and before execution of the job X. In the present embodiment, the password is input through the screen of FIG. 11, which will be described later. The screen of FIG. 11 is displayed on the computer device 902.

When a password for permitting execution of the job X has been input via the screen of FIG. 11, as described above, the MFP control unit 205 causes the digital multifunction peripheral 904 to execute the job X during a period in which the plurality of priority functions are collectively inhibited.

If the password input via the screen of FIG. 11 is erroneous, it is determined that a correct password has not been input. In this case, as described above, even when the request is previously accepted, the MFP control unit 205 controls the digital multifunction peripheral 904 not to execute (to inhibit) the job X. In this case, according to the flowchart described below, print data for the job received from the computer device 902 is discarded (deleted) from the HDD 206 and execution of the job by the digital multifunction peripheral 904 is cancelled.

Thus, according to the job processing system of the present embodiment, when a request for collective inhibition of a plurality of priority functions is received, first, a check occurs to determine whether the request is to be accepted. Further, when the job X is executed, the job processing system also checks whether the execution be permitted. By performing the two checkings, high security is maintained while the effects as described above can be obtained.

In the present embodiment, the MFP control unit 205 performs control so that an operator is informed via UI that all the priority functions have been collectively inhibited.

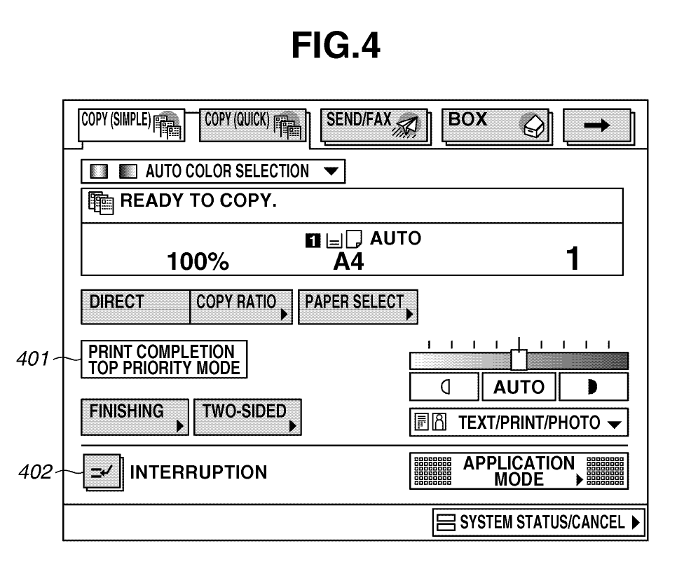

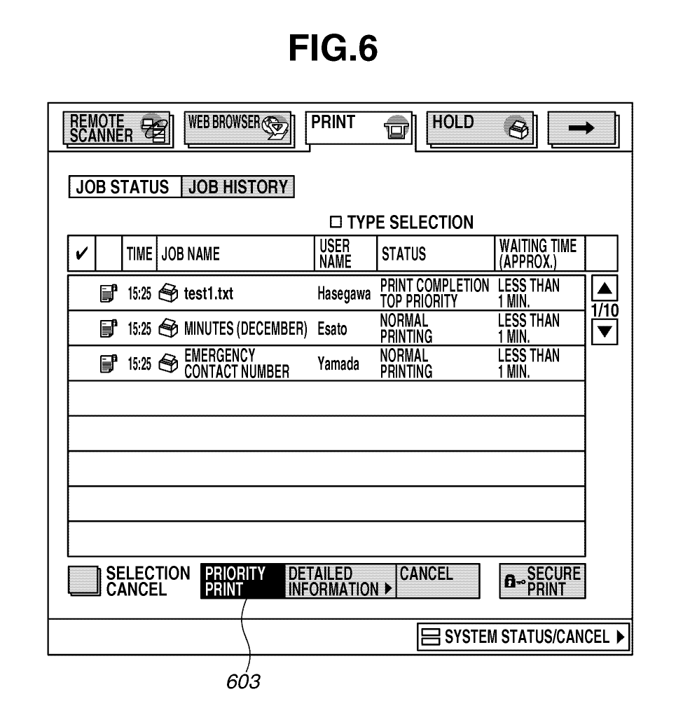

The MFP control unit 205 controls the UI to disable button operation by using gray-out display/hatching display and the like as illustrated at 402 of FIG. 4 and 603 of FIG. 6.

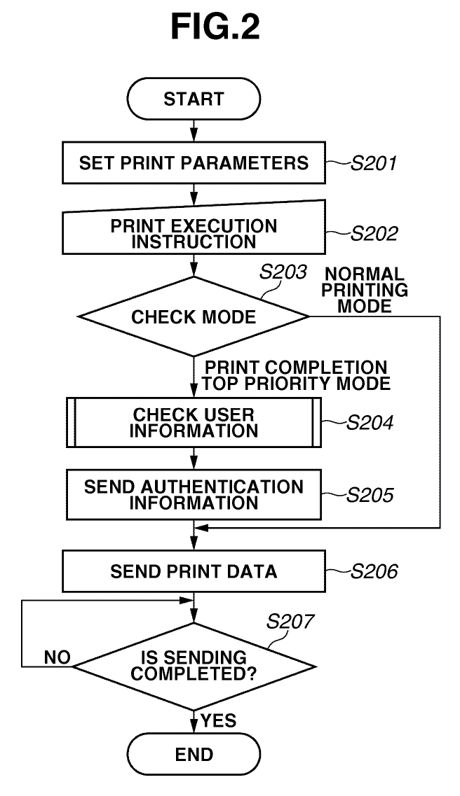

Now, referring to FIGS. 1 and 2, detailed description will be made on examples of various structures mentioned-above. The following configurations are shown as examples and other embodiments can apply to the job processing system according to the present embodiment.

Processing of the flowchart illustrated in FIG. 1 is executed on the digital multifunction peripheral 904 side. Processing of the flowchart illustrated in FIG. 2 is executed by the computer device 902 that inputs the job X to the digital multifunction peripheral 904.

First, the processing of FIG. 1 executed on the digital multifunction peripheral 904 side will be described below. The program for executing the processing of FIG. 1 is stored in the ROM 207 and is executed under control of the MFP control unit 205.

In step S101, the MFP control unit 205 determines whether the print completion top priority mode has been selected by the operator via the screen of FIG. 3 displayed on the operation unit 204.

The screen of FIG. 3 includes the interrupt copy button 302 for giving an instruction for the interrupt copy function. The screen of FIG. 3 includes the button 301.

The button 301 is a UI for the operator to input a request for collectively inhibiting all types of priority functions usable in the digital multifunction peripheral 904. These functions include the priority functions 2, 3 in addition to the interrupt copy function.

In display of the screen of FIG. 3, either of the buttons 301 and 302 is not pressed down by the operator.

In a state illustrated in FIG. 3, in step S101 of FIG. 1, the MFP control unit 205 determines whether a button operation (mode selection) has been performed by the operator via the UI of the digital multifunction peripheral 904, based on information from a touch panel sensor.

If the operator determines that the print completion top priority mode has been selected by pressing down the screen button 301 of FIG. 3, the MFP control unit 205 advances the processing from step S101 to step S102. In the present example, when the mode is selected by the operator via UI, it is determined that a request for collectively inhibiting a plurality of priority functions usable in the digital multifunction peripheral 904 has been made by the operator. However, any methods other than such a method may also be used.

In step S102, the MFP control unit 205 displays a UI screen of FIG. 7 on the operation unit 204 of the digital multifunction peripheral as an authentication screen for checking whether the operator who has pressed the button 301 has the authority to use a print completion top priority mode.

At the UI screen of FIG. 7, the operator inputs identification information about the operator.

The UI screen of FIG. 7 includes: a user name input button for inputting the user name of a user who has pressed the button 301 and a user name display field 703 for displaying a user name input with the button 701.

The UI screen of FIG. 7 has the password input button 702 for inputting a password assigned to a user displayed in the user name display field 703. The UI screen has a password display field 704 for displaying a password input by the button 702 in a hidden state.

When an OK button of the UI screen in FIG. 7 is pressed-down by an operator after a user name and a password are input on the UI screen of FIG. 7, the MFP control unit 205 executes authentication processing for identifying the operator.

In the authentication processing in step S102, the MFP control unit 205 checks a user name and a password input via the UI screen of FIG. 7 against authorization information already managed by the memory of the digital multifunction peripheral 904 or an external server. By this operation, it is determined whether the operator is an operator who has the authority to use the print completion top priority mode.

If, as a result of the authentication processing, it is determined that the operator has no authority to use the print completion top priority mode, the MFP control unit 205 advances the processing from step S103 to step S104 without moving to the print completion top priority mode. In this case, a request for collectively inhibiting the plurality of priority functions 1 to 3 has been made from the operator, but is rejected.

When the processing is advanced to step S104, the MFP control unit 205 informs the operator that user authentication has been unsuccessful (rejection of the request) through the UI. In the present example, the MFP control unit 205 controls the operation unit 204 to display the UI screen of FIG. 8 so that the operator is informed of the determination.

If, as an authentication result in step S103, it is determined that the operator has the authority to use the print completion top priority mode, the MFP control unit 205 permits shifting to the print completion top priority mode and advances the processing from step S103 to step S105. This case corresponds to a case in which a request for prohibition made by the operator has been permitted.

In step S105, the MFP control unit 205 collectively inhibits the plurality of priority functions 1 to 3. The inhibition state of the priority functions is maintained until the processing in step S109 has been completed.

In the present example, the MFP control unit 205 controls the operation unit 204 to gray out a soft key for using a priority function, as shown in a gray-out display at 402 in FIG. 4 and 603 in FIG. 6. The UI prevents reception of a request for use of a priority function in this way. A method for using a priority function like this and inhibiting (limiting) execution of a job using the function may be realized by any configuration.

For example, when the operator requests a priority function by pressing down a button thereof, a button operation for the priority function may not be restricted (disabled). Instead, the MFP control unit 205 may perform control such that the request is not followed and is rejected. Thus, the digital multifunction peripheral 904 may prevent change of a job execution order. Alternatively, even if a UI operation for changing the order is performed, control may be performed such that a job is not actually executed in the changed execution order.

Further, in the present example, where all the priority functions 1 to 3 are collectively inhibited in step S105, the MFP control unit 205 controls display contents on a screen so that the operator recognizes that the plurality of the priority functions are in a collectively inhibited status.

For example, after the priority functions 1 to 3 is shifted to an inhibited state, the button 301 in FIG. 3 is kept in a selective state as shown in the screen 401 in FIG. 4, and a background color of the button is colored. This state illustrates that the print completion top priority mode has been selected. Further, after the process shifts to this state, the interrupt copy button 302 in FIG. 3 is grayed out as a non-selective as shown in the screen 402 in FIG. 4. This state illustrates that an interrupt copy function is not usable as the priority function.

In step S105, the MFP control unit 205 determines that the priority print function as well is collectively inhibited and similarly controls display of the screen for using the priority print function. Referring to FIGS. 5 and 6, the detailed example will be described below.

FIGS. 5 and 6 are the same UI screen (job status screen) used to select a priority function displayed on the operation unit 204. FIG. 5 illustrates the UI screen displayed before a priority function is inhibited and FIG. 6 illustrates a screen displayed when the priority function is inhibited.

The job status screen has a list screen 501 displaying a list of print target jobs. Printing of the jobs is not yet completed and the jobs include those in printing and those waiting to be printed. The list 501 not only serves to display the information of the each job but also to allow the operator to select the jobs individually.

The priority print button 503 provided on the job status screen is a display key configured to be used in a case where the number of jobs waiting for printing are two or more. In such a status, the button 503 serves to allow the operator to input an instruction for executing a job waiting for printing that is selected using the list 501 in top priority to other jobs waiting for printing.

The example of FIG. 5 indicates that a total of three jobs exists, including a job in printing that has a job name of [test1.txt]. Such job information is illustrated on the list 501 together with a status of the each job in the same order as the printing order of the three jobs.

An example of FIG. 5 illustrates that a job (a third job on the list) named “Emergency Contact Number” that has received a request for print execution after a printing job named “Minute of Meeting December”, is in a selected status on the list 501.

When the button 503 is pressed down in such a status as illustrated in FIG. 5, the MFP control unit 205 performs control to execute a third print job on the list 501 in priority to other waiting jobs. In the case of this example, the printing order is changed so that a job named “Emergency Contact Number” is printed in priority to the print job of the job named “Minute of Meeting December”.

Thus, in a case where the button 503 is in an operative display state, the operator can designate a priority print function as the priority function 2 described above.

In a case where priority functions are collectively inhibited in step S105 as described above, as shown in the example of FIG. 6, the MFP control unit performs control so that the priority print functions are collectively inhibited in the same ways as other priority functions.

In a case where a priority function is inhibited as described above, the MFP control unit 205 performs control so that the priority print button 503 for using the priority print function is gray-out displayed like 603 in FIG. 6. In this way, the button operation of the priority print function is disabled in addition to the interrupt copy function described above. With this gray-out display, the operator can recognize that the priority function cannot be used similar to other priority functions.

In step S105, the MFP control unit 205 inhibits an overtaking printing function corresponding to the priority function 3 together with the priority functions described above. More specifically, the MFP control unit 205 gray-out displays a display key for using the priority function 3 in the same way as the other priority function buttons. Thus, the overtaking printing function is disabled as a function subjected to collective inhibition.

As illustrated in FIGS. 4 to 6, in the present example, the priority functions are collectively inhibited in step S105 through the authentication processing in step S103.

In the processing after a step S106, the job X is executed by the digital multifunction peripheral 904 after receiving the job X from the computer device 902 during a period in which the priority functions are inhibited.

In step S106, if the external I/F unit receives a remote job corresponding to the job X from the computer device 902 (determines reception of print data), the MFP control unit 205 advances the processing from step S106 to step S107.

In the step S107, the MFP control unit 205 checks the print data of the job against the authentication data (password) received together with the print data of the job. This authentication data is checked as a password necessary to execute a job received from the computer device 902 in step S106.

In the present example, if the computer device 902 receives a password that corresponds with the password associated with a user name of the operator which has passed authentication processing in step S103 and has the authority to make the above request, it is determined to be YES in step S107. On the other hand, if it does not correspond to the password of the operator, it is determined to be NO in step S107. As a result of authentication processing in the step S107, if it is determined that execution of the job can be permitted, the processing is advanced from step S107 to step S109. If it is determined to be “not permitted”, the processing is advanced from step S107 to step S108.

In step S108, the MFP control unit 205, for example, discards print data received as print data of the job to inhibit the digital multifunction peripheral 904 from executing the job received in step S106.

In step S109, the MFP control unit 205 causes the digital multifunction peripheral 904 to execute the job received in step S106. More specifically, the MFP control unit 205 causes the digital multifunction peripheral 904 to print the print data received in step S106 according to print conditions set at the computer device 902.

After it is confirmed by the processing in step S109 that the job received in step S106 has been executed by the digital multifunction peripheral 904 (in this example, after printing of a print job to be output in the print completion top priority mode is completed), the processing advances from step S109 to step S110.

In step S110, the MFP control unit 205 collectively (concurrently) cancels inhibition states (lock states) of the plurality of priority functions being kept in an inhibition state after the processing in step S105.

In the present example, all button operations of a plurality of priority functions 1 to 3 that are available in the digital multifunction peripheral 904 have been disabled. Therefore, all the priority functions are collectively disabled.

More specifically, control is performed such that all display buttons of the respective priority functions 1 to 3 that are gray-out displayed as illustrated by 402 in FIG. 4 and 604 in FIG. 6, are collectively placed in an operative display state as illustrated by 302 in FIG. 3 and 503 in FIG. 5.

In this way, in any case where any screen having buttons of the priority functions is displayed, the MFP control unit 205 performs control such that the buttons of the priority functions on the screen are displayed in an operative display state. Hence, a desired priority function is selectable and available to the operator after the processing in the step S110. Actual operations in selecting the priority function will not be repeated because they are the same as described with respect to priority functions 1 to 3.

By collectively canceling the functions in step S110 in this way, the MFP control unit 205 makes the priority functions arbitrarily available and makes operation of a priority function requested by the operator executable by the digital multifunction peripheral 904.

In the present example, together with collectively canceling lock states of the priority functions 1 to 3 in step S110, the MFP control unit 205 also cancels the print completion top priority mode in step S111.

For example, from step S105, the print completion top priority mode is in a selected state and therefore, in step S111, the MFP control unit 205 cancels the selected state of the mode. At this time, the MFP control unit 205 shows the display button (button 301) of the mode in which a selected state is switched to a non-selected state. For example, a background color of the button 301 is returned to an ordinary color. This operation serves to notify the operator that this mode has been cancelled.

When the processing in step S111 is completed, a serial of operations in FIG. 1 performed by the MFP control unit 205 is ended.

Within a predetermined period from step S105 to step S111 in FIG. 1, as described above, usage of the plurality of priority functions are prohibited. However, other functions that do not fall into such priority functions are controlled by the MFP control unit 205 to be available in the period. For example, with respect to an operation button for selecting the non-priority function, an operative display state is maintained without producing gray-out display and the MFP control unit 205 performs control to permit reception of a new job that uses the function. A job to be executed in step S105 is a print job that uses the printer 203. Accordingly, in the present example, various functions relating to a scan job, a transmission job or a box job, which do not use the printer 203, correspond to non-priority functions and all the operation buttons for the functions are controlled to maintain an operative display state.

When jobs for such non-priority functions are received, the MFP control unit 205 performs control such that the jobs for the non-priority function and jobs to be executed in step S109 are executed concurrently (in parallel) by the digital multifunction peripheral 904. The jobs which do not cause delay in executing a job in step S109 are controlled by the control unit 205 to be received whenever necessary from the scanner 201 or the external I/F even within a period from step S105 to step S111. Such jobs, when received, are controlled by the MFP control unit 205 to be executed regardless of a job to be executed in step S109.

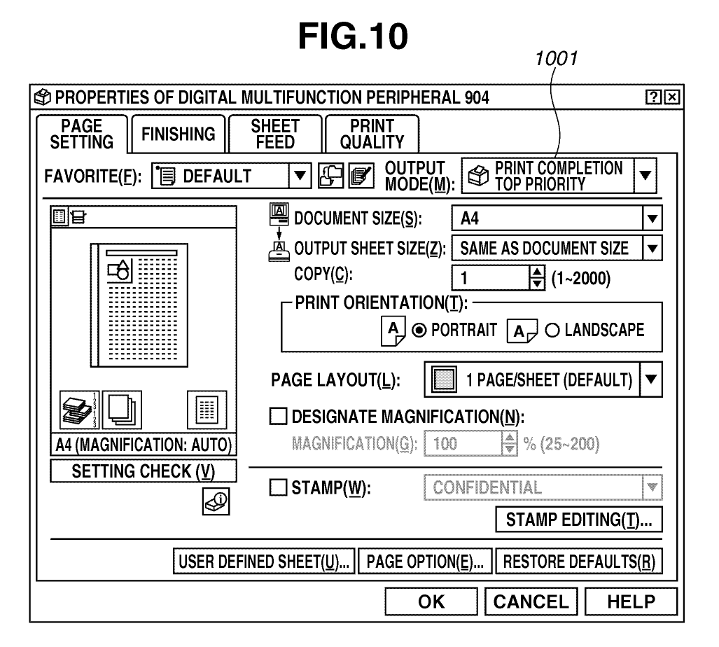

Referring to FIG. 2, FIG. 10 and FIG. 11, a serial of operations executed by the computer device 902 will be described below. The computer device 902 basically has the same internal configuration as the digital multifunction peripheral, except the scanner 201 and the printer 203 in FIG. 12. The computer device 902 has the same functions as the functions implemented by units other than the scanner 201 or the printer 203 in FIG. 12 and therefore, description of the internal configuration will not be repeated. A program for executing a serial of operations in FIG. 2 by the computer device 902 is stored in a ROM (not illustrated) of the computer device 902 and is implemented by a control unit (not illustrated) such as CPU in the computer device 902. The control unit (not illustrated), is hereinafter referred to as a “PC controller”.

First, in step S201, print conditions of a job sent from the computer device 902 are received through a UI screen in FIG. 10. The UI screen in FIG. 10 is displayed on a monitor of the computer device 902. The UI screen in FIG. 10 has a setting field 10001 for the operator who selects the print completion top priority mode or a normal printing mode. It is determined that these settings have been completed when an OK key of the UI screen in FIG. 10 is pressed. Then, the PC controller advances the process to step S202.

In step S202, the PC controller checks a mode selected by the operator.

For example, the print completion top priority mode is selected in the setting field 1001, the process advances from step S203 to step S204. If the normal printing mode is selected in the setting field 1001, the PC controller advances the process from step S203 to step S206.

In step S204, the PC controller causes the UI of the computer device 902 to display the UI screen in FIG. 11 as an authentication information input screen for inputting authentication information (password) necessary to execute the job X. The PC controller prompts a user to enter a user name in an entry field 1101 of the UI screen in FIG. 11 and enter a password associated with the user name in the entry field 1102. Such information is entered using the UI of the computer device, 902 such as a keyboard.

The password input from the UI screen in FIG. 11 is checked by the MFP control unit 205 in the processing of step S107. The processing of step S107 in FIG. 1 is carried out on the digital multifunction peripheral 904 side.

When the authentication information of the job X is input from the UI screen in FIG. 11, the authentication information is sent to the digital multifunction peripheral 904 through LAN 901 together with data indicating the print conditions set in the UI screen in FIG. 10 and print data. The authentication information, the data indicating the print conditions, and the print data are associated with each other as one print job. The serial of these operations are implemented by the processing in step S205 and step S206.

When it is confirmed in step S207 that the data transmission to the digital multifunction peripheral 904 has been implemented, the PC controller makes a determination of YES in step S207, thus completing a serial of operations performed by the PC controller.

In the present example, the MFP control unit 205 cooperate with the PC controller in the way as illustrated in FIGS. 1 and 2. Hence, during a period in which a plurality of priority functions are collectively handled, a job over which no other job takes precedence (job X in the above example), is received from another remote apparatus different from the digital multifunction peripheral 904. The received job is executed during the period by the digital multifunction peripheral 904 without giving any priority to other jobs.

The control program required to execute processing in FIGS. 1 and 2 may be previously stored in a memory or separately downloaded from a program supply source. In the case of downloading the program, a recording medium such as a removable media storing the control program or a data server capable of distributing the control program to one or a plurality of apparatuses via network can serve as the program supply source. The program supply source of the present embodiment is not limited to these two examples, and any other device capable of distributing the control program is applicable to the present embodiment.

As illustrated in FIGS. 1 and 2, a plurality of apparatuses does not always need to cooperate with each other.

For example, as described above, a local job may be a job (job X in the above example) that is to be input during a period in which a plurality of priority functions 1 to 3 is collectively inhibited. In this case, the processing using an image data received from the scanner 201 or HDD 206 is executed as the job X by the digital multifunction peripheral 904. In such a case, in response to an execution instruction from the operation unit 204, a local job corresponding to the job X is made executable. Thus, a scan job or a storing job can be executed as the job X. Accordingly, the present embodiment can be also applied to only one apparatus.

Furthermore, a plurality of jobs having attributes different from each other, such as the scan job, the storing job or a job sent from a computer (PDL job), may be received and executed during a period in which the plurality of priority functions are inhibited.

Furthermore, even when a job over which no other job takes precedence is executed once, inhibition states of a plurality of priority functions may not be automatically and collectively cancelled. In such a case, an explicit request for the cancellation is received from the operator via a UI. The inhibition states of the plurality of priority functions may be collectively cancelled, provided that the request for the cancellation has been received from the operator. In this way, during a period in which a plurality of priority functions are collectively inhibited, a plurality of jobs over which no other job takes precedence is sequentially executed by the digital multifunction peripheral. A job processing system according to the present embodiment may be configured in this manner.

In addition, a local UI such as the operation unit 204 does not always need to be used. For example, the present invention may be configured to receive a request of collective inhibition of a plurality of priority functions according to the present embodiment from a remote UI such as the computer device 902. Further, the present invention may be configured to receive the request from both a local UI and a remote UI.

The exemplary embodiments according to the present invention are configured, as an example, to be applied to a job processing apparatus capable of executing at least a print job like the digital multifunction peripheral. However, the present embodiment may apply to other devices, for example, to a facsimile machine, a mobile phone capable of executing a transmission job for sending an electronic data, and a filing apparatus and a digital camera capable of executing a storage job for storing and managing electronic data in a storage unit. Further, the present embodiment may apply to an apparatus capable of executing a job of recording and/or reproducing an audio data and/or a video data. The job processing system according to the present embodiment is configured to be applied to various types of the electronic apparatuses and devices as long as a plurality of priority functions is usable in these apparatuses and devices.

A control program of various types of structures according to the above-described embodiment is installed, from the outside, in the digital multifunction peripheral 904 according to the above-described embodiment or other apparatuses such as the computer device 902. This program includes, for example, a program code for providing the structure according to the above-described embodiment. The above-described embodiment includes a control program that serves as the UI. Hence, the apparatuses are configured to execute the processing, the determination, the control and the actual operation for the structure according to the above-described embodiment.

In such exemplary embodiments, a control program (program product) itself that can be executed by a computer and is required to serve as a structure according to the present invention constitutes the present invention. A computer-readable recording medium that stores a control program constitutes the present invention. A plurality of structures for function limitation or job control according to the above-described embodiment may be provided by one CPU or a plurality of CPUs.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-056495 filed Mar. 6, 2008, which is hereby incorporated by reference herein in its entirety.

1. A job processing system for causing a job processing unit to execute a job, comprising:
a processing unit configured to perform a plurality of priority functions, which cause the job processing unit to execute a job in priority to another job being executed or waiting to be executed; and
a control unit configured to inhibit collectively the plurality of priority functions upon receiving a request for inhibiting collectively the plurality of priority functions.

2. The job processing system according to claim 1, wherein
when the request is received, the control unit performs control to inhibit collectively the plurality of priority functions and not to inhibit any function that does not correspond to the plurality of priority functions.

3. The job processing system according to claim 1, wherein
the control unit collectively cancels inhibition of the plurality of priority functions on a condition that a job processed by the job processing unit has been executed.

4. The job processing system according to claim 1, further comprising:
an input unit configured to input operator information for identifying an operator prior to the request,
wherein the control unit determines whether the request should be received based on the operator information.

5. The job processing system according to claim 1, further comprising:
a password input unit configured to input a password necessary to execute the job,
wherein the control unit performs control such that the job is not executed unless the password is input by the password input unit.

6. The job processing system according to claim 1, further comprising:
a notifying unit configured to notify an operator that the plurality of priority functions are inhibited collectively.

7. A method for controlling a job processing system capable of causing a job processing unit to execute a job, the method comprising:
performing a plurality of priority functions which cause the job processing unit to execute a job in priority to another job being executed or waiting to be executed; and
inhibiting collectively the plurality of priority functions upon receiving a request for inhibiting collectively the plurality of priority functions.

8. The method according to claim 7, wherein
when the request is received, the plurality of priority functions is inhibited collectively and any function that does not correspond to the plurality of priority functions is controlled not to be inhibited.

9. The method according to claim 7, wherein
inhibition of the plurality of priority functions is collectively canceled, on a condition that a job processed by the job processing unit has been executed.

10. The method according to claim 7, further comprising:
inputting operator information for identifying an operator prior to the request,
wherein it is determined whether the request should be received based on the input operator information.

11. The method according to claim 7, further comprising:
inputting a password necessary to execute the job;
wherein control is performed such that the job is not executed unless the password is input.

12. The method according to claim 7, further comprising notifying the operator that the plurality of priority functions is inhibited collectively.

13. A computer-readable storage medium storing a computer-executable process, the computer-executable process causing a computer to implement a method for controlling a job processing system capable of causing a job processing unit to execute a job, the method comprising:
performing a plurality of priority functions, which cause the job processing unit to execute a job in priority to another job being executed or waiting to be executed; and
inhibiting collectively the plurality of priority functions upon receiving a request for inhibiting collectively the plurality of priority functions via a user interface.
